(19) United States
(12) Patent Application Publication
(10) Pub. No.: US 2023/0171268 A1
(43) Pub. Date: Jun. 1, 2023

(54) INTELLIGENT BOT FOR IMPROVING CYBERSECURITY OPERATIONS AND EDUCATION

(71) Applicant: MICRO FOCUS LLC, Santa Clara, CA (US)

(72) Inventors: Manish Marwah, Pleasanton, CA (US); Martin Fraser Arlitt, Calgary (CA)

(73) Assignee: MICRO FOCUS LLC, Santa Clara, CA (US)

(21) Appl. No.: 17/538,278

(22) Filed: Nov. 30, 2021

(51) Int. Cl. H04L 9/40

(52) U.S. Cl. CPC H04L 63/1416; H04L 63/20; H04L 63/1425; H04L 63/145; H04L 63/0263

(57) ABSTRACT

A security rule associated with an application is identified. This may be done continuously and verified using machine learning models to ensure that the environment characterized by the data has not changed. For example, a security rule may be which ports are open/closed on a firewall. In response to identifying the security rule associated with the application, a security test based on the security rule is generated. For example, the security test may be to test all the ports on the firewall to see which ports are open/closed. The security test against the application is executed to determine if the security rule has been implemented properly by the application.

### BACKGROUND

Organizations constantly face cybersecurity threats and attacks, whose prevention and detection requires deployment of many applications including security management applications. Furthermore, other applications that use network connectivity may depend on these applications to work properly. Configuration, validation, and management of this entire ecosystem of applications is a complex and challenging task. For example, some rules in a security management application may incorrectly trigger and deny access to a user application; the precision of a machine learning-based anomaly detector may degrade significantly during deployment. Using cybersecurity analysts to repeatedly check for such issues is costly; it is most cost-effective to the organization and more rewarding to the cybersecurity analysts to focus on more creative/less repetitive issues.

Furthermore, there is a need to quickly and effectively train cybersecurity staff to detect and troubleshoot various scenarios. Many organizations face staffing shortages for cybersecurity roles and list the cost to train and subsequently retain staff as pain points.

### SUMMARY

These and other needs are addressed by the various embodiments and configurations of the present disclosure. The present disclosure can provide a number of advantages depending on the particular configuration. These and other advantages will be apparent from the disclosure contained herein.

A security rule associated with an application is identified. For example, a security rule may be which ports are open/closed on a firewall. In response to identifying the security rule associated with the application, a security test based on the security rule is generated. For example, the security test may be to test all the ports on the firewall to see which ports are open/closed. The security test against the application is executed to determine if the security rule has been implemented properly by the application.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably, and include any type of methodology, process, mathematical operation or technique.

The term “means” as used herein shall be given its broadest possible interpretation in accordance with 35 U.S.C., Section 112(f) and/or Section 112 Paragraph 6. Accordingly, a claim incorporating the term “means” shall cover all structures, materials. or ads set forth herein. and all the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for improving cybersecurity operations.

FIG. 2 is a flow diagram of a process for improving cybersecurity operations.

FIG. 3 is a flow diagram for flagging changed security rule(s).

FIG. 4 is a flow diagram for identifying potential misconfigurations based on dependencies and/or rule changes.

FIG. 5 is a flow diagram of a process of using identified anomalies/attacks for simulating anomalies/attacks.

FIG. 6 is a diagram of a topic graph that comprises a plurality of topic nodes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

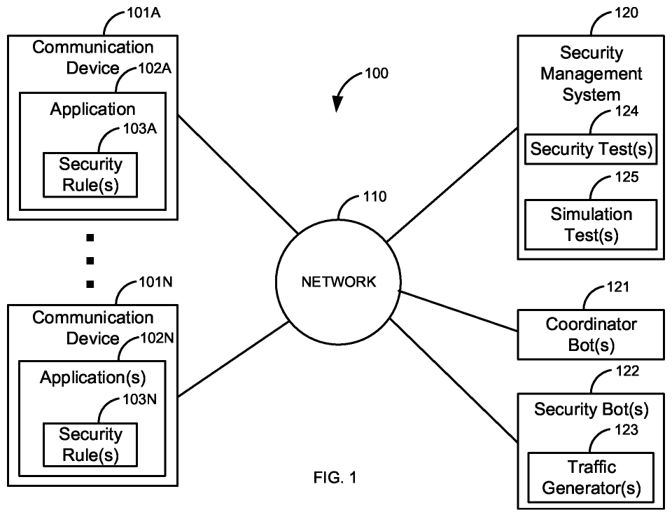

FIG. 1 is a block diagram of a first illustrative system 100 for improving cybersecurity operations. The first illustrative system 100 comprises communication devices 101A-101N, a network 110, a security management system 120, a coordinator bot(s) 121, and a security bot(s) 122.

The communication devices 101A-101N can be or may include any communication device 101 that can communicate on the network 110, such as a Personal Computer (PC), a telephone, a video system, a cellular telephone, a smartphone, a Personal Digital Assistant (PDA), a tablet device, a notebook device, a web server, a security server, a media server, an application server, a router, a gateway, a database server, a Private Branch Exchange (PBX), and/or the like. Any number of communication devices 101A-101N may be connected to the network 110.

The communication devices 101A-101N further comprise applications 102A-102N. In FIG. 1, N (e.g., in 102N) may indicate one or more application(s) per communication device 101. A single communication device 101 may comprise a plurality of applications 102. The applications 102A-102N can be any type of application 102, such as, a firewall, a router, a web server, a security server, an authentication server, a proxy server, a gateway, an operating system, a database, an anti-virus application, a network security application, a security application, a gateway, a Network Address Translator (NAT), an email application, a Virtual Private Network (VPN) application, a quarantine application, a spam filter, and/or the like.

The applications 102A-102N further comprise security rule(s) 103A-103N (e.g., one or more security rules 103 per communication device 101). The security rule(s) 103A-103N can be any security rule 103 that is used to configure/administer the applications 102. The security rules 103A-103N are typically specific to the application 102. For example, a security rule 103 for a firewall may be open/closed ports, a list of good/blocked Universal Resource Locators (URLs), allowed incoming versus outgoing ports, Network Address Translation (NAT) rules, spam filtering rules, and/or the like. The security rules 103 for an anti-virus application 102 may be which ports the anti-virus application 102 uses to get virus pattern updates, supported devices, and/or the like. The security rules 103 for a router may be priority routing rules based on port numbers, applications 102, users, and/or the like. The security rule(s) 103 for an operating system may be which user is granted access to the communication device 101, who is granted access to a database, multi-factor authentication rules, password requirement rules, an amount of data transferred, a number of files accessed, a time of day and/or day of week for these actions, and/or the like. Thus, the security rules 103A-103N for each application 102 may vary based on the type of application 102.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The security management system 120 can be or may include hardware coupled with software that can manage security on the network 110. The security management system 120 may be a network management system. The security management system 120 also manages the coordinator bot(s) 121/security bot(s) 122. The security management system 120 further comprises security test(s) 124 and simulation test(s) 125. The security test(s) 124 are tests that are generated by the security management system 120 for testing the security rule(s) 103 against the application(s) 102. The simulation test(s) 125 are tests that are used to simulate anomalies and/or normal traffic on the network 110/in an application 102 and/or communication device 101 for training cybersecurity analysts. This traffic can be used to identify true positive, false positive, true negative, and false negative results.

The coordinator bot(s) 121 are used to coordinate the generation and execution of simulation tests for training cybersecurity analysts. In addition, the coordinator bot(s) 121 may be used for coordinating additional tests when a problem is detected to try and assist in narrowing in on the root cause as quickly as possible. The coordinator bot(s) 121 may be part of the security management system 120 (i.e., on the same device) or external to the security management system 120 (i.e., on a different device). The coordinator bot(s) 121 coordinate the testing of the application(s) 102 based on the security test(s) 124. The coordinator bot(s) 121 communicate with the security bot(s) 122 to generate network traffic to simulate network anomalies. The security bot(s) 122 generate network traffic via the network traffic generator(s) 123. For example, a coordinator bot 121 may communicate with a plurality of security bots 122 to generate specific traffic on different sub-nets of the network 110. The security bot(s) 122 may also do more than just generate network traffic. For example, the security bot(s) 122 may be installed on the communication device 101 and make Application Programming Interface (API) calls to test the security rule(s) 103 of an application 102. For example, the API call may be for an anti-virus program 102 to get anti-virus pattern updates to verify that the anti-virus program 102 security rules 103 are working properly.

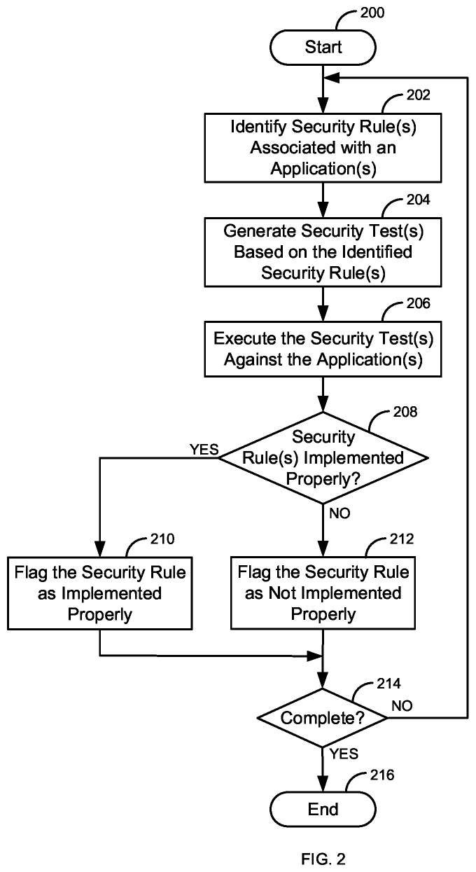

FIG. 2 is a flow diagram of a process for improving cybersecurity operations. Illustratively, the communication devices 101A-101N, the applications 102A-102N, the security rules 103A-103N, the security management system 120, the coordinator bot(s) 121, the security bot(s) 122 and the traffic generators 123 are stored-program-controlled entities, such as a computer or microprocessor, which performs the method of FIGS. 2-5 and the processes described herein by executing program instructions stored in a computer readable storage medium, such as a memory (i.e., a computer memory, a hard disk, and/or the like). Although the methods described in FIGS. 2-5 are shown in a specific order, one of skill in the art would recognize that the steps in FIGS. 2-5 may be implemented in different orders and/or be implemented in a multi-threaded environment. Moreover, various steps may be omitted or added based on implementation.

The process starts in step 200. The security management system 120 identifies security rule(s) 103 associated with the application(s) 102 in step 202. The security management system 120 may identify the security rules 103A-103N in various ways, such as, receiving the security rule(s) 103 from the application(s) 102, making an Application Programming Interface (API) call (e.g., API calls provided by the application(s) 102), accessing a database that contains the security rule(s) 103, opening a file that contains the security rule(s) 103, reading a Simple Network Management Protocol (SNMP) Management Information Database (MIB), querying the application(s) 102, and/or the like.

The security management system 120 generates security test(s) 124 based on the identified security rule(s) 103 in step 204. The generated security test(s) 124 may be generated by selecting existing tests from a stored group of security test(s) 124, automatically generating the security test(s) 124, and/or the like. For example, the application 102A may be a firewall and the security rules 103A define which ports are open/closed on the firewall. The generated security test(s) 124 test if the open/closed ports on the firewall match the security rule 103A. The security management system 120 executes the security test(s) 124 (e.g., via the coordinator bot(s) 121/security bot(s) 122/traffic generator(s) 123) against the application(s) 102 in step 206. The security management system 120, determines, in step 208, if the security rule(s) 103 were implemented properly. If the security rule(s) 103 were implemented properly in step 208, the security management system 120 flags the security rule(s) 103 as being implemented properly in step 210. The process then goes to step 214. If the security rule(s) 103 were not implemented properly in step 208, the security management system 120 flags the security rule(s) 103 as not being implemented properly in step 212. The flagging may include sending an alert to an administrator to investigate the root cause of the problem or signal a robot/script/playbook if there is a known solution to the problem. The process then goes to step 214.

The security management system 120 determines, in step 214, if the process is complete. If the process is complete in step 214, the process ends in step 216. In another embodiment, rather than ending, the process may periodically repeat the process to recheck the security tests. Otherwise, if the process is not complete in step 214, the process goes back to step 202.

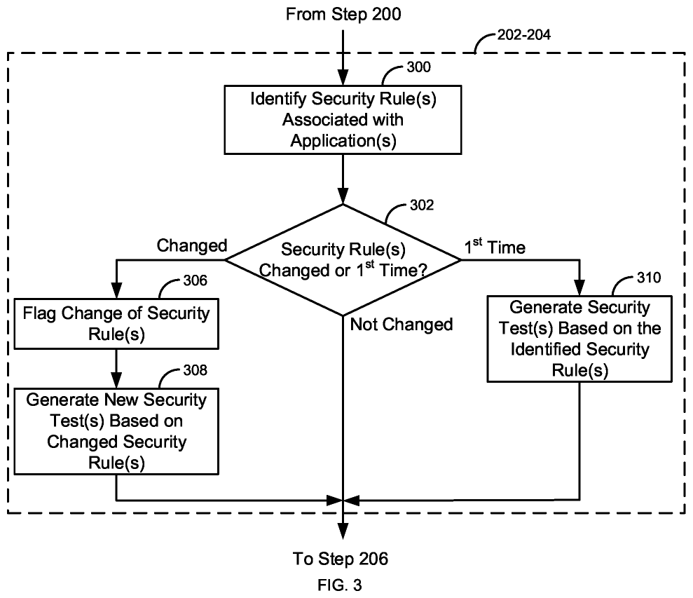

FIG. 3 is a flow diagram for flagging changed security rule(s) 103. FIG. 3 is an exemplary embodiment of steps 202-204 of FIG. 2. After starting in step 200 or coming from step 214, the security management system 120 identifies the security rule(s) 103 associated with the application(s) 102 in step 300. The security management system 120, determines, in step 302, if the security rule(s) 103 have changed or if it is the first time in the process. For example, if a new port was opened on the firewall, security management system 120 would determine that the security rule(s) 103 changed in step 302.

If the security rule(s) 103 have changed in step 302, the security management system 120 flags the change of the security rule(s) 103 in step 306. The purpose of flagging the changes in the security rule(s) 103 is to help identify if the changes in the security rule(s) 103 cause failures/problems in other application(s) 102 or within the same application 102. For example, the newly closed port may cause another application 102 to fail, such as an anti-virus program that uses the closed port for virus updates. When the change is flagged in step 306, information associated with the change can also be identified, such as, the time of the change, a date of the change, a type of the change, dependent applications 102, who made the change, and/or the like. The security management system 120 generates, in step 308, new security test(s) 124 based on the changed security rule(s) 103. The process then goes to step 206 of FIG. 2 where the new security test(s) 124 are executed.

If it is the first time for generating the security rule(s) 103 in step 302, the security management system 120 generates, in step 310, the security test(s) 124 based on the identified security rule(s) 103. The process then goes to step 206 where the security test(s) 124 are executed. Otherwise, if the security rule(s) 103 have not changed and it is not the first time in step 302 (i.e., it uses the previously generated security test(s) 124 of step 310), the process goes to step 206 where the security test(s) 124 are executed.

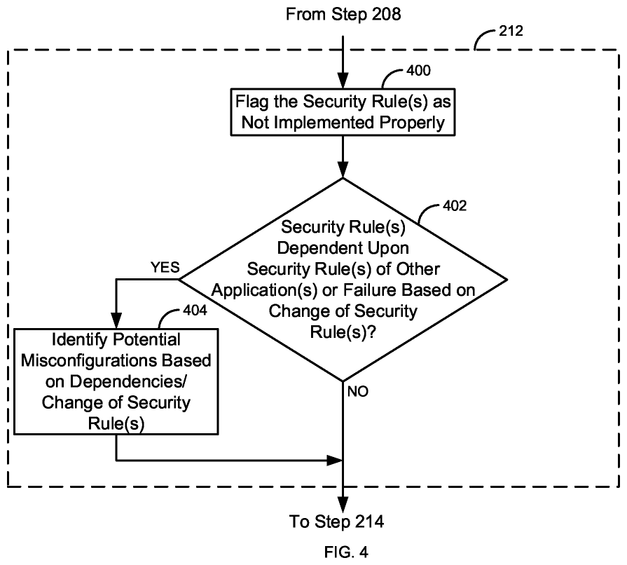

FIG. 4 is a flow diagram for identifying potential misconfigurations based on dependencies and/or security rule 103 changes. FIG. 4 is an exemplary embodiment of step 212 of FIG. 2. After identifying that the security rule(s) 103 was not implemented properly in step 208, the security management system 120 flags the security rule(s) 103 as not being implemented properly in step 400. The security management system 120 determines, in step 402, if the security rule(s) 103 are dependent upon other security rule(s) 103 of other application(s) 102 or there is a failure based on a change of the security rule(s) 103 (e.g., as identified in step 306). If the security rule(s) 103 are not dependent upon security rule(s) 103 of other application(s) 102 or there is not a failure based on a change of security rule(s) 103 in step 402, the process goes to step 214.

Otherwise, if there are dependencies on the security rule(s) 103 of other applications 102 or a failure based on a change in security rule(s) 103 in step 402, the security manager 120 identifies potential misconfigurations based on the dependencies/change of security rule(s) 103. For example, if a firewall port changed from open to closed where an anti-virus program uses the now closed port for virus pattern updates, the security management system 120 could identify the relationship between the two applications 102. In this example, the security rules 103 for the anti-virus application 102 would fail because the anti-virus application 102 can no longer get the updated anti-virus patterns. The security management system 120 determines the relationship because the anti-virus program 102 uses the closed port. The process then goes to step 214.

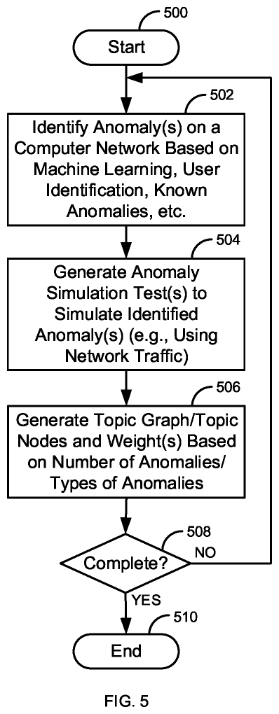

FIG. 5 is a flow diagram of a process of using identified anomalies/attacks for simulating anomalies/attacks. The process starts in step 500. The security management system 120 identifies, in step 502, one or more anomalies/attacks on the computer network 110, within an application 102, between applications 102, coming in external to the network 110, and/or the like. The identification of the anomalies/attacks may be identified in various ways, such as, using machine learning, based on user identification, of known anomalies/attacks, historical information, and/or the like. The machine learning may use supervised machine learning, unsupervised machine learning, semi-supervised machine learning, and/or the like. For example, an anomaly may be a new pattern of beaconing on the network 110 that is identified by an unsupervised machine learning process where a new malware application 102 is periodically beaconing and uploading data outside the network 110. The anomaly/attack may be a known pattern of an attempted Denial of Service (DoS) attack on a firewall. The anomaly may be something that was administered by a user (e.g., by a cybersecurity analyst).

Machine learning models may be routinely trained for detecting threats and intrusions. However, during model deployment the data seen is usually not the same as that used during training. Although models can be trained to perform well on “out of distribution” data, at some point the machine learning model would need to be retrained as the current data distribution diverges further from the data used during training. Therefore, there is a need to closely monitor the performance of a deployed machine learning model. The Security Bot(s) 121 could proactively test the models on more recent data and monitor various performance metrics such as accuracy, recall, and precision. Synthetic data generated from more recent data could also be used to test the machine learning models.

The security management system 120 generates simulation test(s) 125 to simulate the identified anomaly(s) in step 504. For example, the security management system 120 may send instructions to the coordinator bot(s) 121 that causes the coordinator bot(s) 121 to send messages to the security bot(s) 122 to cause the traffic generator(s) 123 to simulate the anomaly, such as, a denial-of-service attack. The generated traffic may be based on previously captured packet traces of the anomaly/attack. The instructions may be for a security bot 122 to make API calls to simulate the anomaly. Alternatively, the security bot 122 may be an application that simulates an attempt to break a password of an operating system user or an application password. One of skill in the art would appreciate that there may be any number of ways that could be used to simulate generating an anomaly/attack.

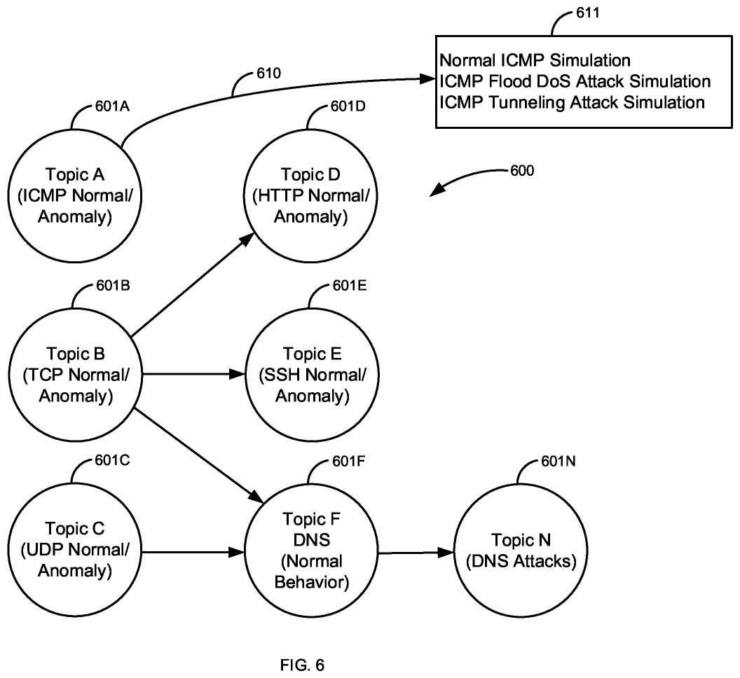

From the generated simulation test(s) 125, the security management system 120 generates, in step 506, a topic graph/topic nodes (e.g., as described in FIG. 6) and weights based on various factors, such as, how often the anomaly occurs, the type of anomaly, a user defined weight, a severity of the anomaly, and/or the like. Step 506 may include input from a security analyst. The management security system 120 determines, in step 508, if the process is complete. If the process is not complete in step 508, the process goes back to step 502. Otherwise, if the process is complete in step 508, the process ends in step 510.

FIG. 6 is a diagram of topic graph 600 that comprises a plurality of topic nodes 601A-601N. Although the illustrative topic graph 600 comprises seven topic nodes 601A-601N, there may be any number of topic nodes 601 in the topic graph 600 depending upon implementation. The topic graph 600 is displayed to a user in a graphical user interface that is provided by the security management system 120. The topic graph 600 is used to train the user based on the various topics that are represented by the topic nodes 601A-601N. The topic nodes 601A-601N may be created based the generated security tests 124 of step 204 and/or other processes described herein, including pre-generated simulation tests, captured network traffic, and/or the like.

The topic node 601A is used to train the user for both normal behavior and anomalies/attacks (e.g., attacks that use the Internet Control Message Protocol (ICMP)). For example, when the user selects topic node 601A in step 610, the user is presented with a tests window 611. In FIG. 6, the tests window 611 shows three simulations that the user can run: 1) a Normal ICMP Simulation, 2) an ICMP Flood Denial-of-Service (DoS) Attack Simulation, and 3) an ICMP Tunneling Attack Simulation. The user can select the ICMP Normal Test to simulate normal ICMP traffic. When the user selects the ICMP flood DoS Attack Simulation, the security bot(s) 122 can generate traffic to simulate the ICMP Flood DoS Attack by generating a large amount of ping packets directed toward a firewall (e.g., the application 102A). This allows the user to be able to learn how to identify this type of attack. For example, the user can access the security management system 120 to generate the ICMP Flood DoS attack, see the generated ICMP traffic, and try to diagnose the ICMP flood DoS Attack using the normal security tools. The ICMP flood DoS attack is used to identify routing errors via ICMP error messages to learn attack points within the network 110.

The topic node 601B allows the user to train on the Transmission Control Protocol (TCP), by simulating both normal behavior and various anomalies/attacks associated with the TCP protocol. When the user selects topic node 601B, a tests window 611 for the TCP simulations is displayed. For example, the user can select a TCP SYN Packet Simulation where the security bot(s) 122 generate TCP SYN packets without acknowledging the SYN-ack packet for a time period. Thus, it creates a large amount half-open illegitimate TCP connections. The result is that legitimate TCP connections cannot be established. The user can then use the security management system 120 to identify the TCP SYN attack.

The topic node 601B has dependent topic nodes 601D-601F. The topic node 601D is for the Hyper Text Transfer Protocol (HTTP). The dependency is because HTTP is an application layer protocol that uses TCP as its network layer protocol. The topic node 601E is for the Secure Socket Shell (SSH) protocol. Like HTTP, SSH also uses TCP as its network layer protocol. The topic node 601F is for the Domain Name System (DNS) protocol. Like for HTTP and SSH, DNS may use TCP as its network layer protocol.

The topic node 601D is used to train the user for both normal behavior and anomalies/attacks for the HTTP protocol. Like described above using the tests window 611, the user is trained on anomalies/attacks associated with the HTTP protocol. For example, the training may be to generate network traffic to simulate a HTTP host header attack or a HTTP DoS attack.

The topic node 601E is used to train the user for both normal behavior and anomalies/attacks for SSH. Like described above using the tests window 611, the user is trained on anomalies/attacks associated with the SSH protocol. For example, a SSH brute-force attack may be simulated by the security bot(s) 122. The SSH brute-force attack simulates a brute force attack by using various usernames/passwords to gain access to a device/system.

The topic node 601F is used to train the user for normal behavior of the DNS protocol. When the user selects the topic node 601F, the user is trained on what DNS traffic regularly looks like. For example, the security bot(s) 122 may generate traffic to simulate normal DNS traffic. The user can then use the security management system 120 to view how the normal DNS traffic works. If the user wants to simulate specific DNS attacks/anomalies, the user can select the topic node 601N. Using the tests window 611, the user can select various types of simulations of DNS attacks, such as, a DNS flood attack, a domain hijacking attack, a cache poisoning attack, and/or the like.

The topic node 601C is used to train the user for both normal behavior and/anomalies/attacks associated with User Datagram Protocol (UDP). For example, the user may be able to select from the tests window 611, a normal UDP simulation, a UDP Flood DoS attack, and/or the like. The topic node 601C has the topic nodes 601F/601N (DNS) as dependent nodes like the topic node 601B. Here, instead of using TCP as the network layer protocol, the simulation uses UDP as the network layer protocol when running the normal/anomaly/attack simulations for the DNS protocol.

Although most of the examples above are attack types, anomalies can be simulated. For example, a periodic TCP connection can be simulated to train a cybersecurity analyst to identify virus that has just become active on the network 110.

In addition, the security management system 120 can evaluate the student's progression, skip certain topics if the student has demonstrated a good understanding of previous topics with similar characteristics, and/or put the user through additional similar topics if they have struggled with similar topics.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM1926EJS™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits several known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

Several variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
identify a first security rule associated with a first application;
in response to identifying the first security rule associated with the first application, generate a first security test based on the first security rule; and
execute the first security test against the first application to determine if the first security rule has been implemented properly by the first application.

2. The system of claim 1, wherein the microprocessor readable and executable instructions further cause the microprocessor to:
identify a second security rule associated with a second application;
in response to identifying the second security rule associated with the second application, generate a second security test based on the second security rule; and
execute the second security test against the second application to determine if the second security rule has been implemented properly by the second application.

3. The system of claim 2, wherein the microprocessor readable and executable instructions further cause the microprocessor to:
in response to executing the second security test against the second application, determine that the second security rule has not been implemented properly by the second application; and
in response to determining that the second security rule has not been implemented properly by the second application, identify a misconfiguration in the first security rule that caused the second security rule to not be implemented properly.

4. The system of claim 1, wherein the microprocessor readable and executable instructions further cause the microprocessor to:
identify a change in the first security rule;
in response to identifying the change in the first security rule, generate a second security test based on the changed first security rule; and
execute the second security test against the first application to determine if the changed first security rule has been implemented properly by the first application.

5. The system of claim 4, wherein the microprocessor readable and executable instructions further cause the microprocessor to flag the change in the first security rule, wherein the flagged change to the first security rule is used to identify a failure of a second security rule of a second application.

6. The system of claim 1, wherein executing the first security test is managed by a coordinator bot and the first security test is executed by a security bot that generates network traffic that is received by the first application.

7. The system of claim 1, wherein the microprocessor readable and executable instructions further cause the microprocessor to:
identify an anomaly and/or attack on a computer network; and
based on identifying the anomaly and/or attack on the computer network, generate a simulation test to simulate the identified anomaly and/or attack, wherein the generated simulation test is based on rules and/or machine learning models and wherein the simulation test comprises at least one of: generating network traffic to simulate the anomaly and/or attack and making an Application Programming Interface (API) call to simulate the anomaly and/or attack.

8. The system of claim 7, wherein the simulation test comprises a plurality of simulation tests, wherein the plurality of simulation tests are used to generate a topic graph that represents the plurality of simulation tests, and wherein the topic graph is used for training a user.

9. The system of claim 8, wherein the topic graph comprises a plurality of topic nodes, wherein at least some of the plurality of topic nodes are related to one another based on the plurality of simulation tests, and where the plurality of topic nodes are assigned a weight based on a number of anomalies and/or attacks that have been identified on the computer network.

10. A method comprising:
identifying, by a microprocessor, a first security rule associated with a first application;
in response to identifying the first security rule associated with the first application, generating, by the microprocessor, a first security test based on the first security rule; and
executing, by the microprocessor, the first security test against the first application to determine if the first security rule has been implemented properly by the first application.

11. The method of claim 10, further comprising:
identifying a second security rule associated with a second application;
in response to identifying the second security rule associated with the second application, generating a second security test based on the second security rule; and
executing the second security test against the second application to determine if the second security rule has been implemented properly by the second application.

12. The method of claim 11, further comprising:
in response to executing the second security test against the second application, determining that the second security rule has not been implemented properly by the second application; and
in response to determining that the second security rule has not been implemented properly by the second application, identifying a misconfiguration in the first security rule that caused the second security rule to not be implemented properly.

13. The method of claim 10, further comprising:
identifying a change in the first security rule;
in response to identifying the change in the first security rule, generating a second security test based on the changed first security rule; and
executing the second security test against the first application to determine if the changed first security rule has been implemented properly by the first application.

14. The method of claim 13, further comprising, flagging the change in the first security rule, wherein the flagged change to the first security rule is used to identify a failure of a second security rule of a second application.

15. The method of claim 10, wherein executing the first security test is managed by a coordinator bot and the first security test is executed by a security bot that generates network traffic that is received by the first application.

16. The method of claim 10, further comprising:
identifying an anomaly and/or an attack on a computer network; and
based on identifying the anomaly and/or attack on the computer network, generating a simulation test to simulate the identified anomaly and/or attack, wherein the generated simulation test is based on rules and/or machine learning models and wherein the simulation test comprises at least one of: generating network traffic to simulate the anomaly and/or attack and making an Application Programming Interface (API) call to simulate the anomaly and/or attack.

17. The method of claim 16, wherein the simulation test comprises a plurality of simulation tests, wherein the plurality of simulation tests are used to generate a topic graph that represents the plurality of simulation tests, and wherein the topic graph is used for training a user.

18. The method of claim 17, wherein the topic graph comprises a plurality of topic nodes, wherein at least some of the plurality of topic nodes are related to one another based on the plurality of simulation tests, and where the plurality of topic nodes are assigned a weight based on a number of anomalies that have been identified on the computer network.

19. A non-transient computer readable medium having stored thereon instructions that cause a microprocessor to execute a method, the method comprising instructions to:
identify a first security rule associated with a first application;
in response to identifying the first security rule associated with the first application, generate a first security test based on the first security rule; and
execute the first security test against the first application to determine if the first security rule has been implemented properly by the first application.

20. The non-transient computer readable medium of claim 19, wherein the instructions further cause the microprocessor to:
identify an anomaly and/or an attack on a computer network; and
based on identifying the anomaly and/or attack on the computer network, generate a simulation test to simulate the identified anomaly and/or attack, wherein the generated simulation test is based on rules and/or machine learning models and wherein the simulation test comprises at least one of: generating network traffic to simulate the anomaly and/or attack and making an Application Programming Interface (API) call to simulate the anomaly and/or attack.
